(19) United States
(12) Patent Application Publication
(10) Pub. No.: US 2013/0058439 A1
(43) Pub. Date: Mar. 7, 2013

(54) Receiver

(71) Applicant: Ying-Yao Lin, Hsinchu County (TW)

(72) Inventor: Ying-Yao Lin, Hsinchu County (TW)

(21) Appl. No.: 13/226,443

(22) Filed: Sep. 6, 2011

(51) Int. Cl. H04L 27/06

(52) U.S. Cl. 375/340

(57) ABSTRACT

The present invention discloses a receiver for a communication system. The receiver includes at least one power detector, for detecting the power value of the processed signal of a received signal; a dynamic analog to digital converter (ADC), having a variable set point and a variable dynamic range; and a Digital Signal Processor (DSP), for adjusting the variable set point and the variable dynamic range according to the power value.

### BACKGROUND OF THE INVENTION

1. Field of the Invention

The present invention relates to a receiver for a communication system, and more particularly, to a receiver capable of dynamically controlling a set point and a dynamic range of an analog to digital converter (ADC), to enhance jammer immunity with low current consumption.

2. Description of the Prior Art

Conventionally, a receiver of a communication system includes an analog to digital converter (ADC) for converting analog signals to digital signals. The conventional ADC has a fixed set point and a fixed dynamic range during operations. Therefore, in order to prevent the ADC from distortion due to out-band or in-band jammers, the conventional receiver either includes an expensive surface acoustic wave (SAW) filter to filter the out-band or in-band jammers, or includes an over-designed ADC with a wide dynamic range, i.e. a large fixed number of ADC bits or ENOB value.

For example, please refer to FIG. 1A, which is a schematic diagram of a conventional receiver 10 of a communication system. As shown in FIG. 1A, the receiver 10 includes a low noise amplifier (LNA) 100, a mixer 102, a low-pass filter 104, a programmable gain amplifier (PGA) 106 and an ADC 108. The LNA 100 amplifies a received signal RSig, to output a processed signal PSig₁. The mixer 102 mixes the processed signal PSig₁ with a desirable frequency to output a processed signal PSig₂. The low-pass filter 104 filters the processed signal PSig₂ with a low frequency band to output a processed signal PSig₃. The PGA 106 amplifies the processed signal PSig₃ to output an input signal INSig with a fixed center power at a fixed set point of the ADC 108. The ADC 108 converts the analog input signal INSig into a digital signal with the fixed set point and a fixed dynamic range. In such a configuration, if there is a strong out-band or in-band jammer in the received signal RSig, the analog input signal INSig may swing beyond the fixed dynamic range of the ADC 108, resulting in distortion of the ADC 108.

Specifically, please refer to FIG. 1B, which is a schematic diagram of operations of the ADC 108 shown in FIG. 1A when there is a strong jammer or no jammer in the received signal RSig. As shown in FIG. 1B, the ADC 108 has an upper limit of 2 dBm, a fixed set point of −4 dBm, a fixed dynamic range of 12 dB, e.g. 2 bits, a quantization noise power of −10 dBm, and a signal to noise ratio (SNR) of 6 dBm. Under an ideal condition, there is no jammer in the received signal RSig, and thus the PGA 106 outputs the input signal INSig with a fixed center power of −4 dBm and small voltage swing lower than the upper limit (a solid line). As a result, the ADC 108 can operate normally without distortion.

However, when there is no jammer in the received signal RSig, and the PGA 106 may output the input signal INSig with a fixed center power of −4 dBm and a large voltage swing, e.g. 7 dBm greater than 6 dBm, beyond the fixed dynamic range (a dotted line). As a result, the ADC 108 cannot operate normally due to distortion since the power of the input signal INSig may exceed the upper limit.

Under such a situation, the conventional receiver 10 needs an expensive surface acoustic wave (SAW) filter in a front end or an inter-stage SAW filter between the LNA 100 and the mixer 102, to filter the out-band jammers, resulting in high cost. Otherwise, the ADC 108 may be over-designed to have a wide dynamic range, i.e. a large fixed number of ADC bits or ENOB value, resulting in high current consumption. Therefore, there is a need to improve over the prior art.

### SUMMARY OF THE INVENTION

FIG. 1A is a schematic diagram of a conventional receiver of a communication system.

FIG. 1B is a schematic diagram of operations of an ADC shown in FIG. 1A when there is a strong jammer or no jammer in a received signal RSig.

FIG. 2A is a schematic diagram of a receiver of a communication system according to an embodiment of the present invention.

FIG. 2B is a schematic diagram of operations of a dynamic ADC shown in FIG. 2A when there is a strong jammer or no jammer in a received signal according to an embodiment of the present invention.

FIG. 2C is a schematic diagram of the dynamic ADC shown in FIG. 2A according to an embodiment of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional receiver of a communication system.

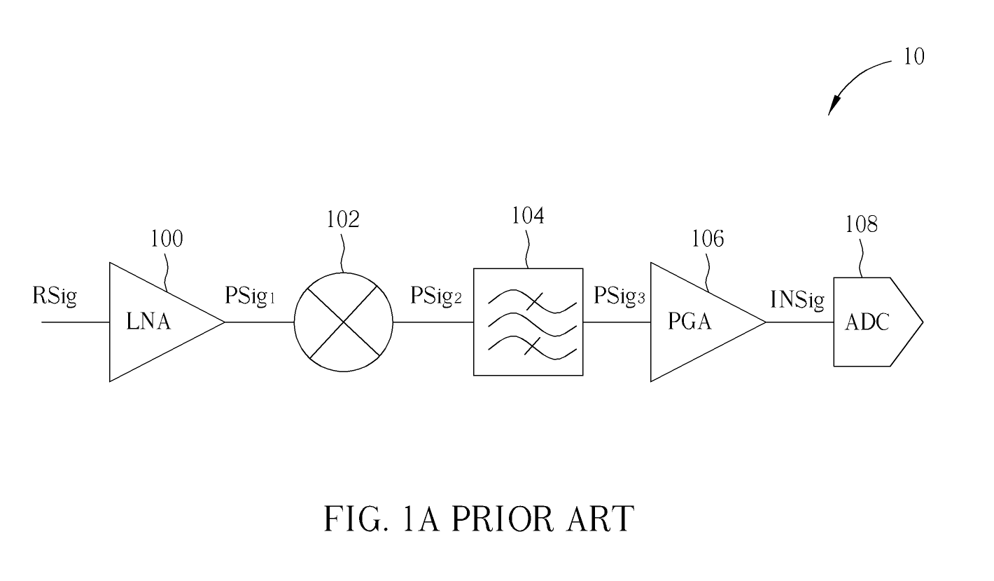

FIG. 1B is a schematic diagram of operations of an ADC shown in FIG. 1A when there is a strong jammer or no jammer in a received signal RSig.

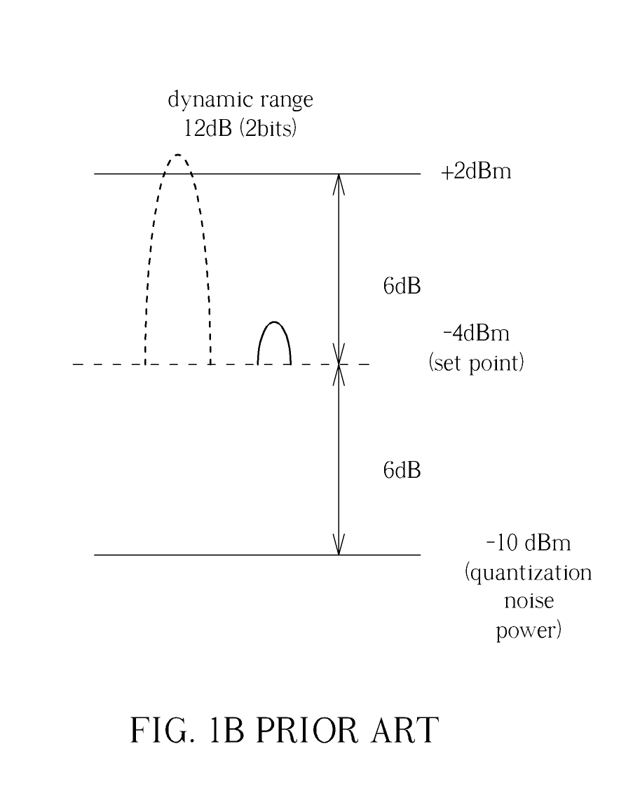

FIG. 2A is a schematic diagram of a receiver of a communication system according to an embodiment of the present invention.

FIG. 2B is a schematic diagram of operations of a dynamic ADC shown in FIG. 2A when there is a strong jammer or no jammer in a received signal according to an embodiment of the present invention.

FIG. 2C is a schematic diagram of the dynamic ADC shown in FIG. 2A according to an embodiment of the present invention.

### DETAILED DESCRIPTION

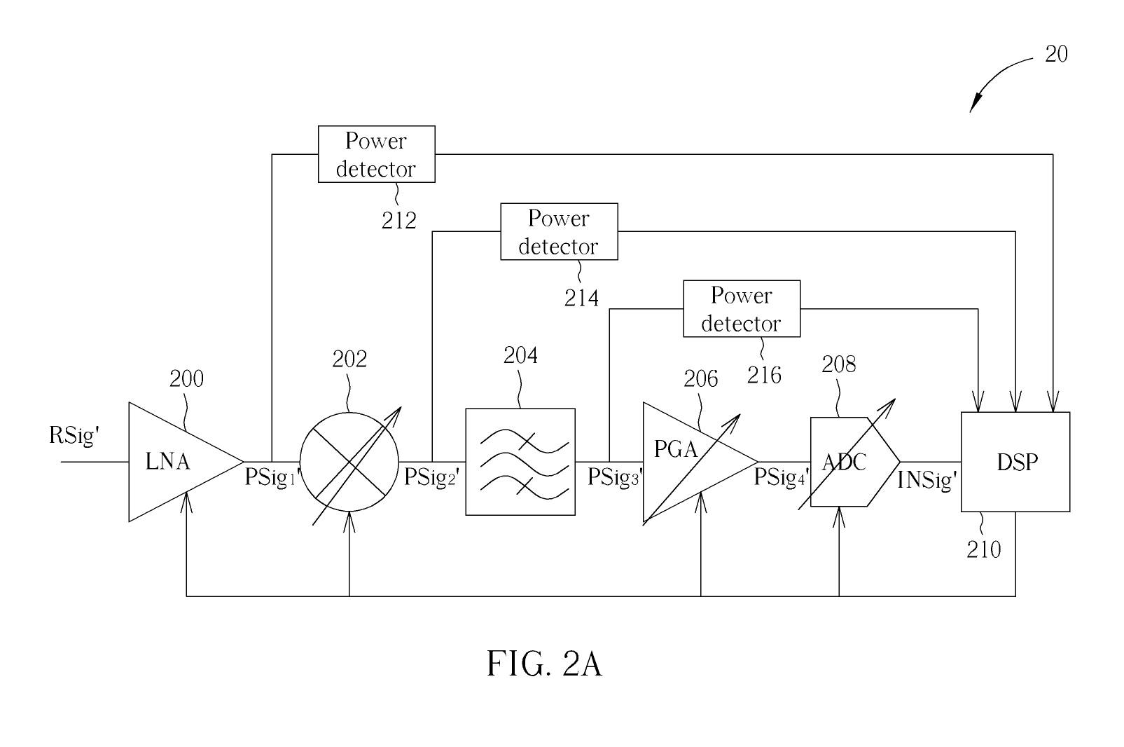

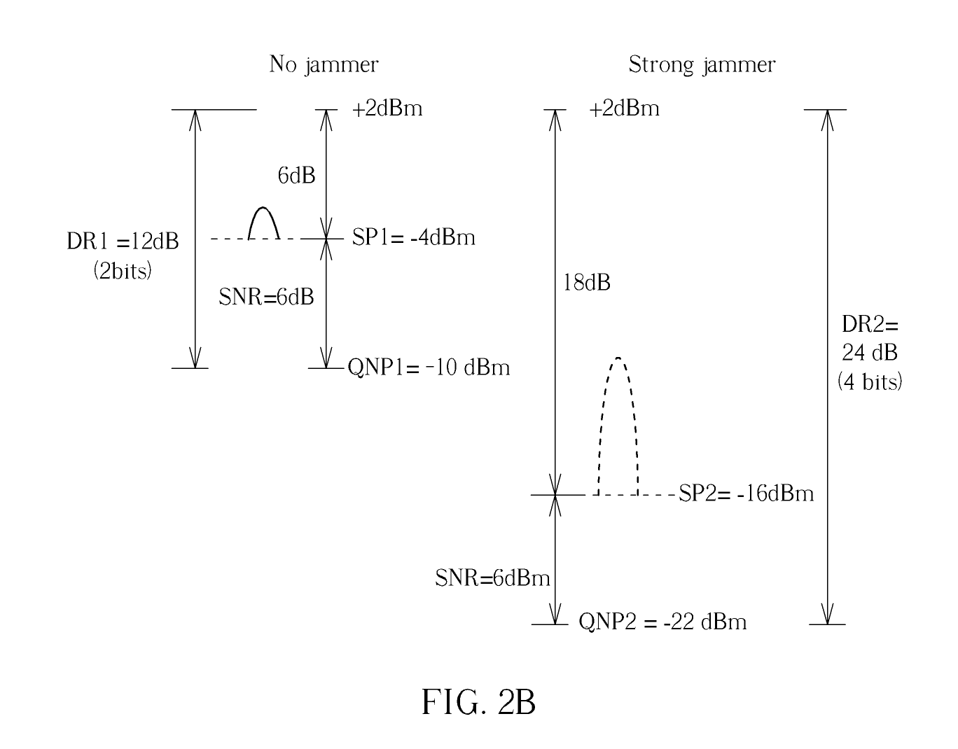

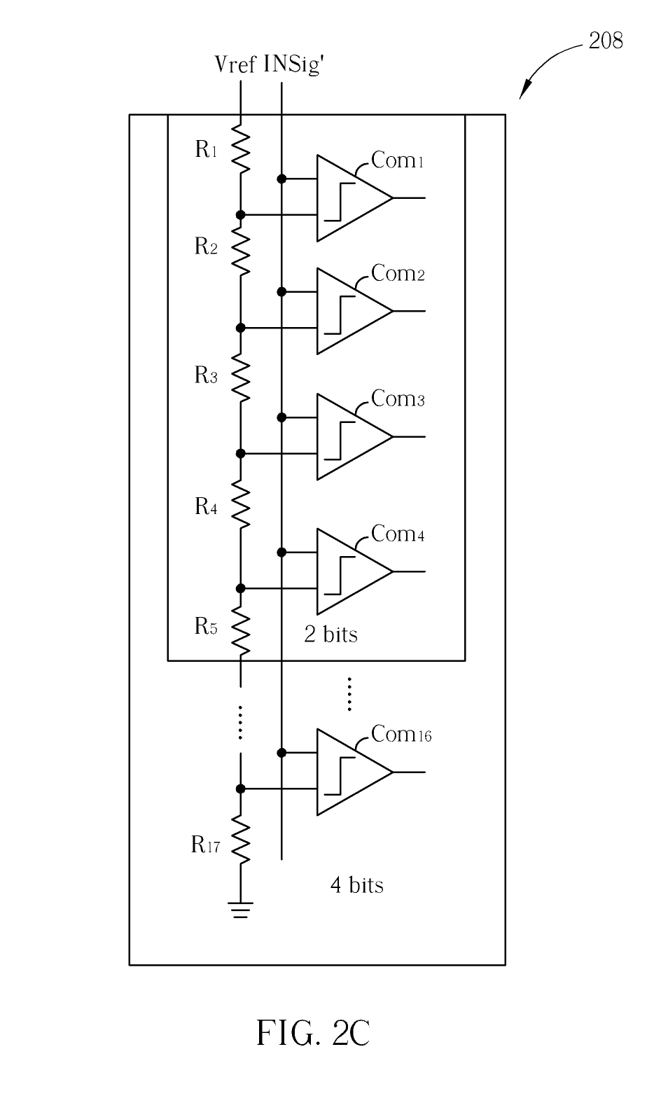

Please refer to FIG. 2A, which is a schematic diagram of a receiver 20 of a communication system according to an embodiment of the present invention. As shown in FIG. 2A, the receiver 20 includes a low noise amplifier (LNA) 200, a mixer 202, a low-pass filter 204, a programmable gain amplifier (PGA) 206, an dynamic ADC 208, a Digital Signal Processor (DSP) 210 and power detectors (or peak detectors) 212-216. Main differences between the receiver 20 and the receiver 10 are that the power detectors 212-216 are added for detecting power value P₁-P₃ of processed signals PSig₁′-PSig₃′ of a received signal RSig′, and the dynamic ADC 208 has a variable set point and a variable dynamic range, such that the DSP 210 can adjust the variable set point and the variable dynamic range according to the power value P₁-P₃. As a result, the dynamic ADC 208 can operate with low current consumption when there is no jammer in the received signal RSig′, and operate without distortion when there is a jammer in the received signal RSig′.

In details, please refer to FIG. 2B, which is a schematic diagram of operations of the dynamic ADC 208 shown in FIG. 2A when there is a strong jammer or no jammer in the received signal RSig′ according to an embodiment of the present invention. As shown in FIG. 2B, the dynamic ADC 208 has an upper limit of 2 dBm, a set point SP1 of −4 dBm, a dynamic range DR1 of 12 dB, e.g. 2 bits, a quantization noise power QNP1 of −10 dBm, a set point SP2 of −16 dBm, a dynamic range DR2 of 24 dB, e.g. Obits, a quantization noise power QNP2 of −22 dBm and a signal to noise ratio (SNR) of 6 dBm. If there is a strong jammer in the received signal RSig′, one of the power value P₁-P₃ is greater than a predefined value. Therefore, when the power value P₁-P₃ is lower than the predefined value, the DSP 210 fixes the variable set point and the variable dynamic range of the dynamic ADC 208 to the set point SP1 and the dynamic range DR1. Under such a situation, since there is no jammer in the received signal RSig′, the PGA 206 outputs the input signal INSig′ with a center power of −4 dBm and small voltage swing lower than the upper limit (a solid line). As a result, the dynamic ADC 208 can utilize the higher set point SP1 and the narrower dynamic range DR1 to convert the input signal INSig′ with low current consumption when there is no jammer in the received signal RSig′.

On the other hand, if one of the power value P₁-P₃ is greater than the predefined value, the DSP 210 adjusts the variable set point and the variable dynamic range of the dynamic ADC 208 from the set point SP1 and the dynamic range DR1 to the set point SP2 lower than the set point SP1 and the dynamic range DR2 wider than the dynamic range DR1, where the dynamic ADC 208 has more headroom for a strong jammer, i.e. 18 dB, and a same SNR. Under such a situation, since there is a strong jammer in the received signal RSig′, the PGA 206 can output the input signal INSig′ with a center power of −16 dBm and a large voltage swing, e.g. 7 dBm, still lower than the upper limit (a dotted line). As a result, the dynamic ADC 208 can utilize the lower set point SP2 and the wider dynamic range DR2 to convert the input signal INSig′ without distortion when there is a jammer in the received signal RSig′.

Specifically, please refer to FIG. 2C, which is a schematic diagram of the dynamic ADC 208 shown in FIG. 2A according to an embodiment of the present invention. As shown in FIG. 2C, the dynamic ADC 208 includes divider resistors R₁-R₁₇ and comparators Com₁-Com₁₆. The DSP 210 enables a number of enabled divider resistors from the divider resistors R₁-R₁₇ and a number of enabled comparators from the comparators Com₁-Com₁₆, for dividing a reference voltage Vref to compare with the input signal INSig′, so as to adjust the variable dynamic range of the dynamic ADC 208. For example, when there is no jammer in the received signal RSig′, the DSP 210 enables the divider resistors R₁-R₅ and the comparators Com₁-Com₄, such that the dynamic ADC 208 has a narrower dynamic range of 12 dB, i.e. 2 bits; when there is a jammer in the received signal RSig′, the DSP 210 enables the divider resistors R₁-R₁₇ and the comparators Com₁-Com₁₆, such that the dynamic ADC 208 has a wider dynamic range of 24 dB, i.e. Obits. As a result, the DSP 210 can enable different numbers of divider resistors and comparators of the dynamic ADC 208 and thus the dynamic ADC 208 can have different dynamic ranges.

On the other hand, please continue to refer to FIG. 2A. The LNA 200 amplifies the received signal RSig′, to output the processed signal PSig₁′. The mixer 202 mixes the processed signal PSig₁′ with a desirable frequency to output the processed signal PSig₂′. The low-pass filter 204 filters the processed signal PSig₂′ with a low frequency band to output the processed signal PSig₃′. The PGA 206 amplifies the processed signal PSig₃′ by a variable gain to adjust a center power of the input signal INSig′ for the dynamic ADC 208, to adjust the variable set point of the dynamic ADC 208. For example, when there is no jammer in the received signal RSig′, the PGA 206 can apply a higher gain to output the input signal INSig′ of −4 dBm; when there is a jammer in the received signal RSig′, the PGA 206 can apply a lower gain to output the input signal INSig′ of −16 dBm. As a result, the PGA 206 can apply different gains to output the input signal INSig′ with different center power values.

Besides, the DSP 210 can properly adjust the LNA 200, the mixer 202 and the PGA 206 according to different jammers. In an embodiment, the power detector 212 is coupled between the LNA 200 and the mixer 202, and detects the power value P₁ of the processed signals PSig₁′. Since the processed signal PSig₁′ is not mixed by the mixer 202, the power value P₁ of the processed signal PSig₁′ is greater than the predefined value if there is a strong out-band jammer in the received signal RSig′. Therefore, if the power value P₁ is greater than the predefined value, the DSP 210 lowers a gain of the LNA and a gain of the mixer 202 and adjusts the variable gain of the PGA, to lower the burden of the mixer 202 and output the input signal INSig′ of a lower center power value.

In another embodiment, the power detector 214 is coupled between the mixer 202 and the low-pass filter 204, and detects the power value P₂ of the processed signals PSig₂′. Since the processed signal PSig₂′ is mixed by the mixer 202, the power value P₂ of the processed signal PSig₂′ is greater than the predefined value if there is a strong in-band jammer in the received signal RSig′. Therefore, if the power value P₂ is greater than the predefined value, the DSP 210 lowers the variable gain of the PGA 206, to output the input signal INSig′ of a lower center power.

In a further embodiment, the power detector 216 is coupled between the low-pass filter 204 and the PGA 206, and detects the power value P₃ of the processed signals PSig₃′. Since the processed signal PSig₃′ is mixed by the mixer 202, the power value P₃ of the processed signal PSig₃′ may be greater than the predefined value if there is a strong in-band jammer in the received signal RSig′. Therefore, if the power P₃ is greater than the predefined value, the DSP 210 lowers the variable gain of the PGA 206, to output the input signal INSig′ of a lower center power.

Noticeably, the spirit of the present invention is to detect whether there is a jammer in the received signal RSig′, such that the dynamic ADC 208 can have a higher set point and a narrower dynamic range with low current consumption when there is no jammer in the received signal RSig′, and have a lower set point and a wider dynamic range when there is a jammer in the received signal RSig′, so as to reduce quiescent current consumption. Those skilled in the art should make modifications or alterations accordingly. For example, the receiver 20 is preferably a radio frequency receiver, but can be a receiver of other communication systems. Besides, although the receiver 20 includes three power detectors 212-216 in the above embodiment, the receiver 20 can include at least one of the power detectors 212-216 in other embodiments. Furthermore, the dynamic ADC 208 shown in FIG. 2C is not limited to have only two dynamic ranges, and corresponding modifications can be made to include more components for more dynamic ranges

In the prior art, the conventional receiver 10 may include an expensive surface acoustic wave (SAW) filter in a front end or an inter-stage SAW filter between the LNA 100 and the mixer 102, to filter the out-band jammers, resulting high cost. Otherwise, the ADC 108 may be over-designed to have a wide dynamic range, i.e. a large fixed number of ADC bits or ENOB value, resulting high current consumption. In comparison, the present invention detects whether there is a jammer in the received signal RSig′, such that the dynamic ADC 208 can have a higher set point and a narrower dynamic range with low current consumption when there is no jammer in the received signal RSig′, and have a lower set point and a wider dynamic range when there is a jammer in the received signal RSig′, so as to reduce quiescent current consumption.

Those skilled in the art will readily observe that numerous modifications and alterations of the device and method may be made while retaining the teachings of the invention.

What is claimed is:

1. A receiver for a communication system, comprising:
a front-end device, for receiving at least a signal and outputting at least a processed signal;
at least one power detector, coupled to the front-end device, for detecting a power value of the processed signal;
a dynamic analog to digital converter (ADC), having a variable set point and a variable dynamic range; and
a Digital Signal Processor (DSP), coupled to the at least one power detector and the ADC, for adjusting the variable set point and the variable dynamic range according to the power value.

2. The receiver of claim 1, further comprising a predefined value, wherein the DSP sets the variable set point and the variable dynamic range of the dynamic ADC to a first set point and a first dynamic range when the power value is lower than the predefined value.

3. The receiver of claim 2, wherein the DSP sets the variable set point and the variable dynamic range of the dynamic ADC to a second set point lower and a second dynamic range when at least one of the power value is greater than the predefined value, wherein the second set point is lower than the first set point and the second dynamic range is wider than the first dynamic range.

4. The receiver of claim 1, wherein the dynamic ADC comprises:
a plurality of divider resistors; and
a plurality of comparators, each having a first input terminal for receiving an input signal;
wherein the DSP enables at least one of the divider resistors and at least one of the comparators to adjust the variable dynamic range of the dynamic ADC.

5. The receiver of claim 4, wherein the DSP increases the number of the enabled divider resistors and the number of enabled comparators to increase the variable dynamic range of the dynamic ADC.

6. The receiver of claim 4, wherein the front-end device comprises:
a low noise amplifier (LNA), for amplifying the received signal, to output a first processed signal;
a mixer, coupled to the LNA, for mixing the first processed signal to output a second processed signal;
a low-pass filter, coupled to the mixer, for filtering the second processed signal to output a third processed signal; and
a programmable gain amplifier (PGA), for amplifying the third processed signal by a variable gain to adjust an center power of the input signal for the dynamic ADC, so as to adjust the variable set point of the dynamic ADC.

7. The receiver of claim 6, wherein a first power detector of the power detectors is coupled between the LNA and the mixer, and detects a first power value of the first processed signal, wherein when the first power value is greater than a predefined value, the DSP lowers a gain of the LNA and the variable gain of the PGA.

8. The receiver of claim 6, wherein a second power detector of the at least one power detector is coupled between the mixer and the low-pass filter, and detects a second power value of the second processed signal, wherein when the second power value is greater than a predefined value, the DSP lowers the variable gain of the PGA.

9. The receiver of claim 6, wherein a third power detector of the at least one power detector is coupled between the low-pass filter and the PGA, and detects a third power value of the third processed signal, wherein when the third power value is greater than a predefined value, the DSP lowers the variable gain of the PGA.
